(19) United States
(12) Patent Application Publication
(10) Pub. No.: US 2005/0116945 A1
(43) Pub. Date: Jun. 2, 2005

(54) Mobile information terminal device, information processing method, recording medium, and program

(76) Inventors: Daisuke Mochizuki, Chiba (JP); Tomohisa Tanaka, Tokyo (JP); Makoto Sato, Tokyo (JP)

Correspondence Address: William S. Frommer, Esq.;FROMMER LAWRENCE & HAUG LLP, 745 Fifth Avenue, New York, NY, 10151, US

(21) Appl. No.: 10/973,684

(22) Filed: Oct. 26, 2004

(30) Foreign Application Priority Data
Oct. 28, 2003 (JP) 2003-367224

(51) Int. Cl. H04N 7/14

(52) U.S. Cl. 345/418; 348/14.02

(57) ABSTRACT

A mobile information terminal device of the present invention comprises photographing means for photographing a subject, first display control means for controlling a display operation of images based on the photographed subject by the photographing means, selection means for selecting an image area for recognition from the images the display operation of which is controlled by the first display control means, recognition means for recognizing the image area selected by the selection means, and second display control means for controlling the display operation of a recognition result obtained by the recognition means. According to the present invention, the characters included in the photographed images by the mobile information terminal device can be recognized. Particularly, a predetermined area is able to be selected from the photographed images, and the characters in the predetermined area are recognized.

### CROSS REFERENCE TO RELATED APPLICATION

This application claims priority from Japanese Priority Document No. 2003-367224, filed on Oct. 28, 2003 with the Japanese Patent Office, which document is hereby incorporated by reference.

### BACKGROUND OF THE INVENTION

1. Field of the Invention

The present invention relates to a mobile information terminal device, an information processing method, a recording medium, and a program, and particularly to a mobile information terminal device, an information processing method, a recording medium, and a program which are able to select a predetermined area from photographed images, and display the selected predetermined area after performing a character recognition.

2. Description of the Related Art

In some of conventional built-in camera type mobile telephones, a character string written in a book or the like is photographed by fitting into a display frame on a display screen, whereby to character-recognize images (the character string) within the frame for use as character data inside the mobile terminal.

Proposed as one example of this application is a device configured to photograph a home page address written in an advertisement and character-recognize the home page address, so that the server can be accessed easily (see Patent Document 1) .

Patent Document 1: Japanese Laid-Open Patent Application No. 2002-366463

However, when photographing the character string by fitting into the display frame, a user must photograph the character string while taking care of the size of each character, the inclination of the character string, and the like, and this has been addressed as the problem that the operation becomes cumbersome.

Further, there has been another problem that it is difficult to fit into a display frame only a predetermined character string which the user wishes to character-recognize, out of text.

### SUMMARY OF THE INVENTION

The present invention has been made in view of such circumstances, and thus the present invention is intended to make it possible to photograph a text or the like including character strings which the user wishes to character-recognize, select a predetermined character string from the photographed text images, and character-recognize the predetermined character string.

A mobile information terminal device of the present invention is characterized by including photographing means for photographing a subject, first display control means for controlling a display operation of images based on the photographed subject by the photographing means, selection means for selecting an image area for recognition from the images the display operation of which is controlled by the first display control means, recognition means for recognizing the image area selected by the selection means, and second display control means for controlling the display operation of a recognition result obtained by the recognition means.

The selection means maybe configured to select a starting point and an ending point of the image area for recognition.

The first display control means may be configured to further include aiming control means for further controlling the display operation of a mark for designating the starting point of the images, and effecting the control so as to aim at the image for recognition when the images for recognition are present near the mark.

It maybe configured to further include extracting means for extracting an image succeeding the image area when an expansion of the image area selected by the selection means is instructed.

It maybe configured to further include translating means for translating the recognition result obtained by the recognition means.

It may be configured to further include accessing means for accessing another device based on the recognition result obtained by the recognition means.

An information processing method of the present invention is characterized by including a photographing step of photographing a subject, a first display control step of controlling a display operation of images based on the photographed subject by the processing of the photographing step, a selection step of selecting an image area for recognition from the images the display operation of which is controlled by the processing of the first display control step, a recognition step of recognizing the image area selected by the processing of the selection step, and a second display control step of controlling the display operation of a recognition result by the processing of the recognition step.

A recording medium on which a program is recorded of the present invention is characterized by causing a computer to perform processing which includes a photographing step of photographing a subject, a first display control step of controlling a display operation of images based on the subject photographed by the processing of the photographing step, a selection step of selecting an image area for recognition from the images the display operation of which is controlled by the processing of the first display control step, a recognition step of recognizing the image area selected by the processing of the selection step, and a second display control step of controlling a display operation of a recognition result by the processing of the recognition step.

The program of the present invention is characterized by causing the computer to perform a processing which includes a photographing step of photographing a subject, a first display control step of controlling a display operation of images based on the subject photographed by the processing of the photographing step, a selection step of selecting an image area for recognition from the images the display operation of which is controlled by the processing of the first display control step, a recognition step of recognizing the image area selected by the processing of the selection step, and a second display control step of controlling a display operation of a recognition result by the processing of the recognition step.

In the present invention, a subject is photographed, images based on the photographed subject are displayed, an image area for recognition is selected from the displayed images, the selected image area is recognized, and then the recognition result is finally displayed.

According to the present invention, the photographed images can be character-recognized. Particularly, a predetermined area is able to be selected from the photographed images, and thus predetermined area is character-recognized.

### BRIEF DESCRIPTION OF THE DRAWINGS

FIG. 1 is a diagram showing an example configuration of the appearance of a built-in camera type mobile telephone to which the present invention is applied;

FIG. 2 is a block diagram showing an example configuration of the internal part of the mobile telephone;

FIG. 3 is a flowchart illustrating a character recognition processing;

FIG. 4 is a flowchart illustrating details of an aiming mode processing in step S1 of FIG. 3;

FIG. 5 is a diagram showing an example of a display operation of a designated point mark;

FIG. 6 is a diagram illustrating an area around the designated point mark;

FIG. 7 is a diagram sowing an example of a display operation of an aiming-done mark;

FIG. 8 is a flowchart illustrating details of a selection mode processing in step S2 of FIG. 3;

FIG. 9 is a diagram showing an example of a display operation of a character string selection area;

FIGS. 10A to 10G are diagrams showing operations of selecting images for recognition;

FIG. 11 is a flowchart illustrating a processing of extracting a succeeding image in processing of step S26 of FIG. 8;

FIG. 12 is a flowchart illustrating details of a result displaying mode processing in step S3 of FIG. 3;

FIG. 13 is a diagram showing an example of a display operation of a character recognition result;

FIG. 14 is a diagram showing an example of a display operation of a translation result;

FIG. 15 is a diagram showing an example configuration of a server access system to which the present invention is applied;

FIG. 16 is a diagram showing an example of a display operation of the designated point mark;

FIG. 17 is a diagram showing an example of a display operation of the character string selection area;

FIG. 18 is a diagram showing a state in which images for recognition have been selected;

FIG. 19 is a flowchart illustrating details of the result displaying mode processing in step S3 of FIG. 3;

FIG. 20 is a diagram showing an example of a display operation of a character recognition result; and

FIGS. 21A and 21B are diagrams showing an example configuration of the appearance of a mobile information terminal device to which the present invention is applied.

### DETAILED DESCRIPTION OF THE INVENTION

While the best mode for carrying out the present invention will be described hereinafter, an example of correspondence between the disclosed invention and its embodiment(s) is as follows. The fact that an embodiment is described in the present specification, but is not described here as corresponding to an invention would not mean that the embodiment does not correspond to the invention. Conversely, the fact that an embodiment is described here as corresponding to an invention would not mean that the embodiment does not correspond to an invention other than the invention.

Furthermore, this description would not mean to comprehend all the inventions described in the specification. In other words, this description should not be construed as denying the presence of invention(s) which is described in the specification but which is not claimed in this application, i.e., the presence of invention(s) resulting from divisional applications, appearing and added by amendment, and the like in the future.

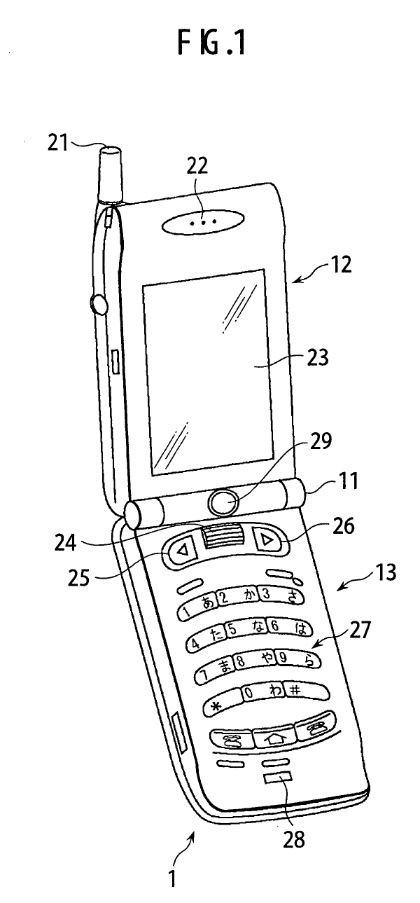

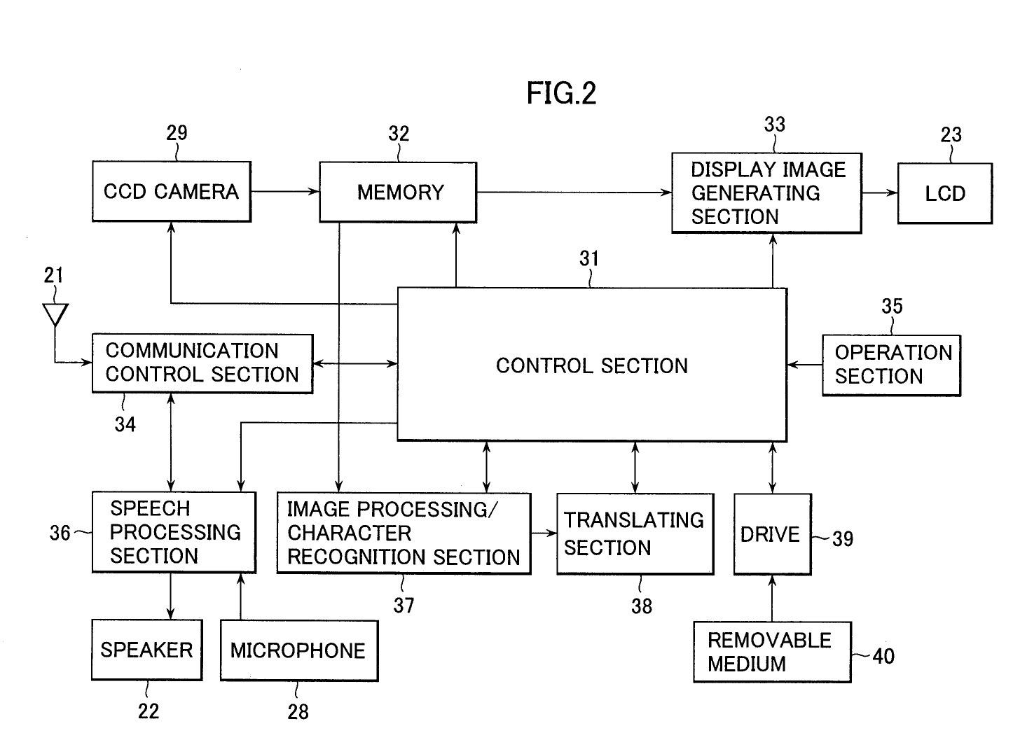

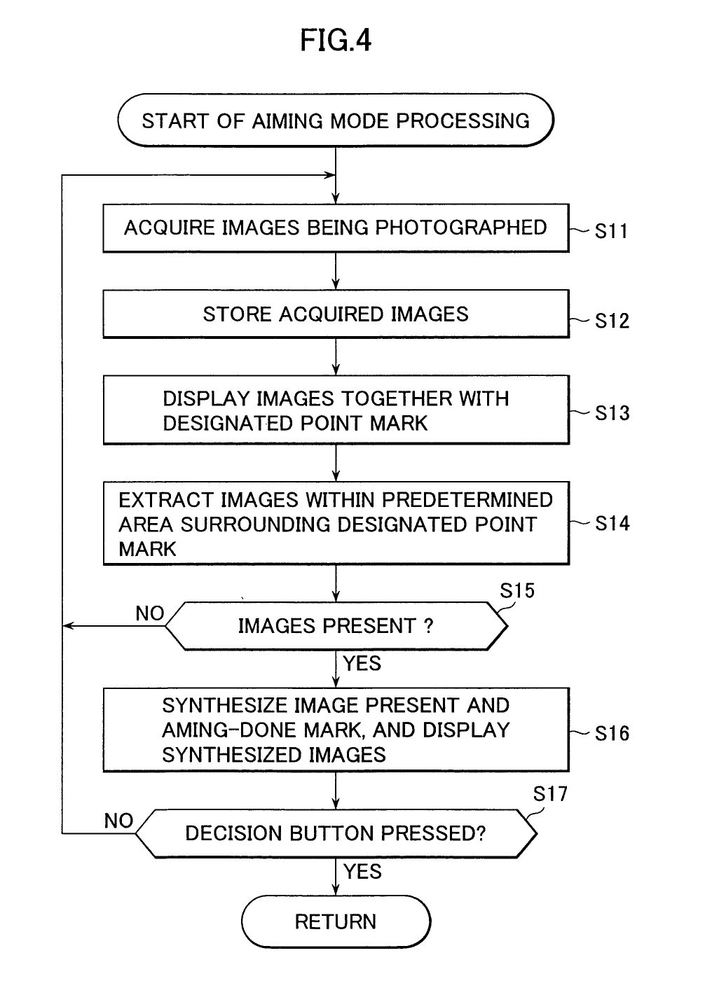

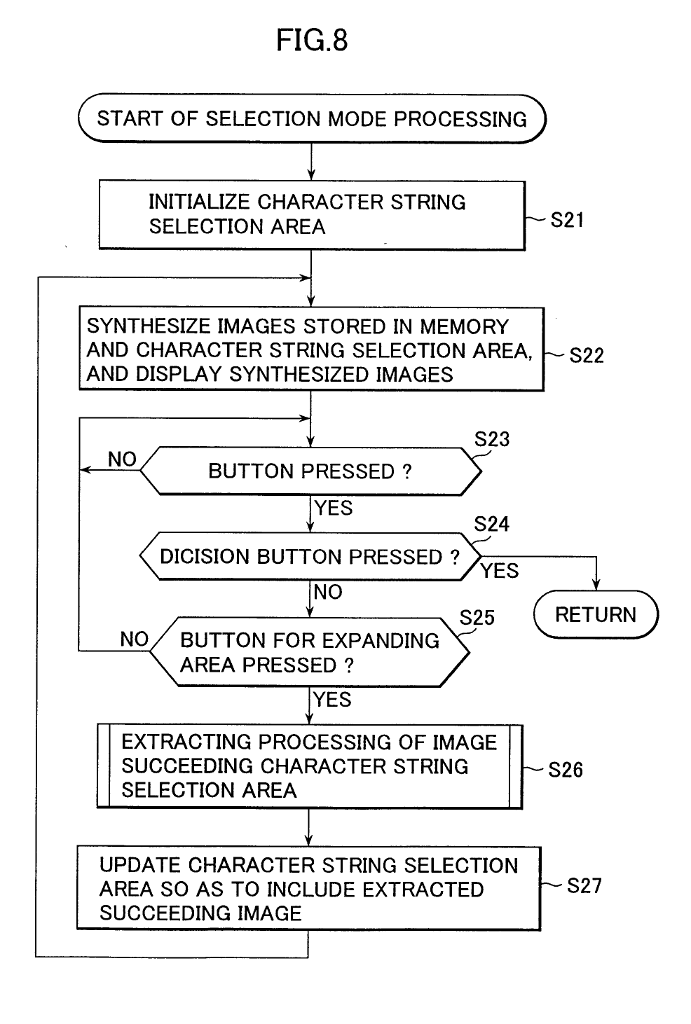

The present invention provides a mobile information terminal device including photographing means for photographing a subject (e.g., a CCD camera 29 of FIG. 1 and FIG. 2 that performs the processing of step S11 of FIG. 4), first display control means for controlling a display operation of images based on the subject photographed by the photographing means (e.g., an LCD 23 of FIGS. 1 and 2 that performs the processing of step S13 of FIG. 4), selection means for selecting an image area for recognition, from the images the display operation of which is controlled by the first display control means (e.g., a display image generating section 33 of FIG. 2 that performs the processing of steps S22 to S27 of FIG. 8, and a control section 31 of FIG. 2 that performs the processing of steps S23 to S26 of FIG. 8), recognition means for recognizing the image area selected by the selection means (e.g., an image processing/character recognition section 37 of FIG. 2 that performs the processing of step S51 of FIG. 12), and second display control means for controlling a display operation of a recognition result by the recognition means (e.g., the LCD 23 of FIGS. 1 and 2 that performs the processing of step S53 of FIG. 12).

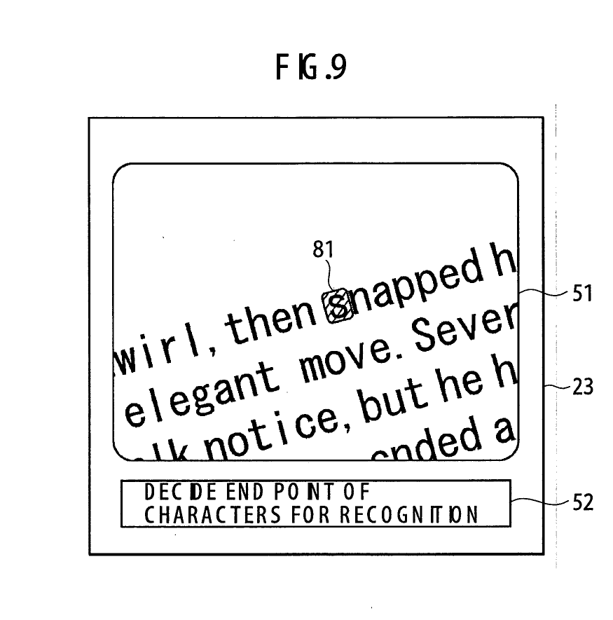

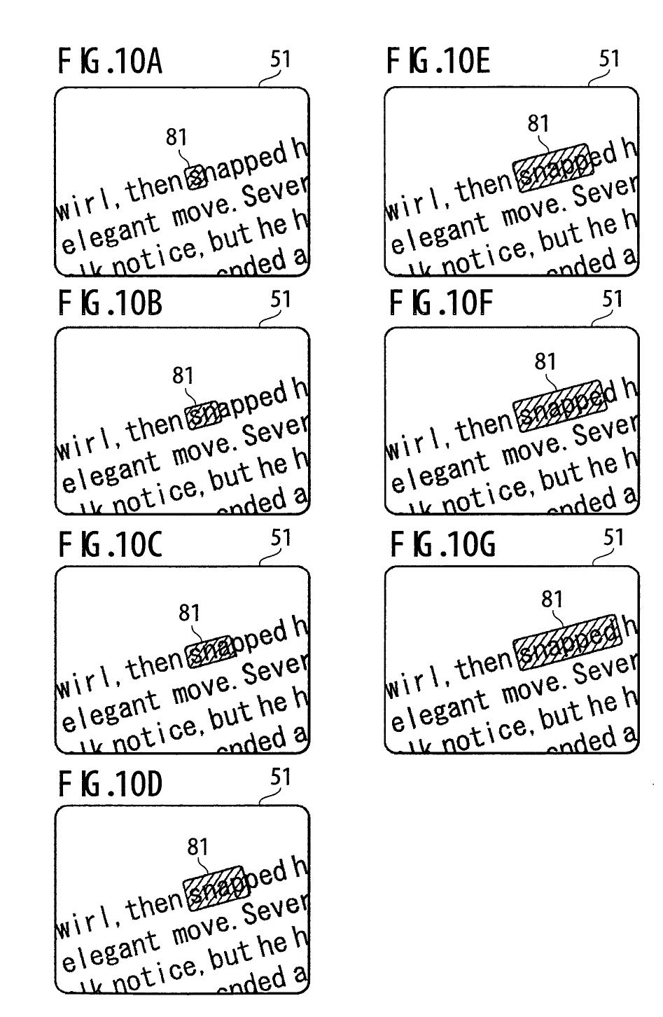

The selection means maybe configured to select a starting point and an ending point of the image area for recognition (e.g., such as shown in FIGS. 10A to 10G).

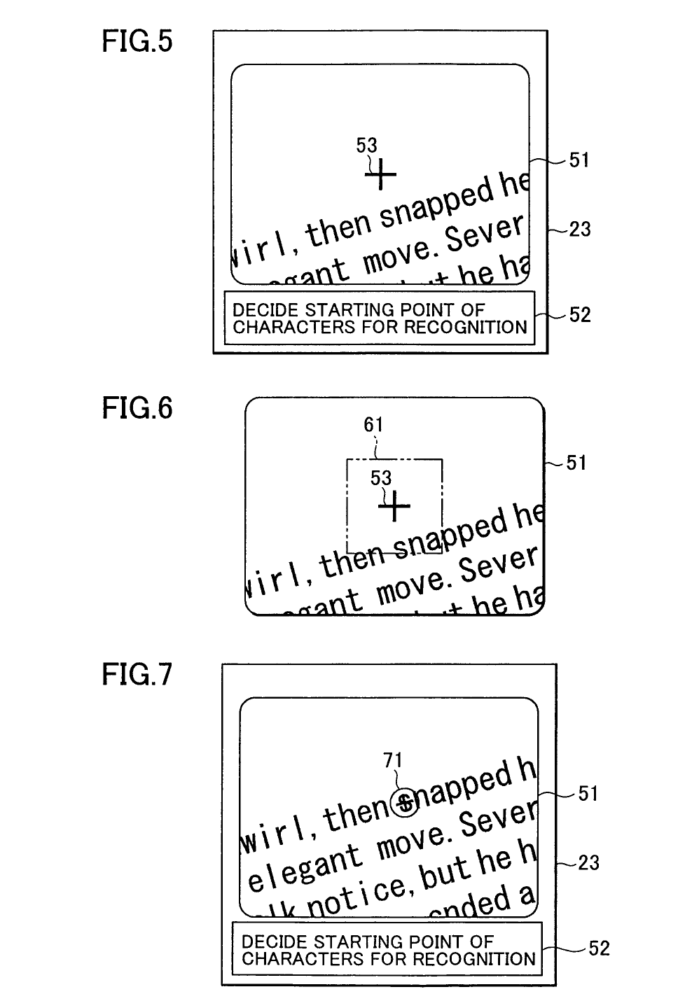

In this mobile information terminal device, the first display control means may be configured to further include aiming control means (e.g., the control section 31 of FIG. 2 that performs the processing of step S16 of FIG. 4) for further controlling a display operation of a mark for designating the starting point of the images (e.g., the designated point mark 53 shown in FIG. 5), and effecting control so as to aim at an image for recognition when the images for recognition are present near the mark.

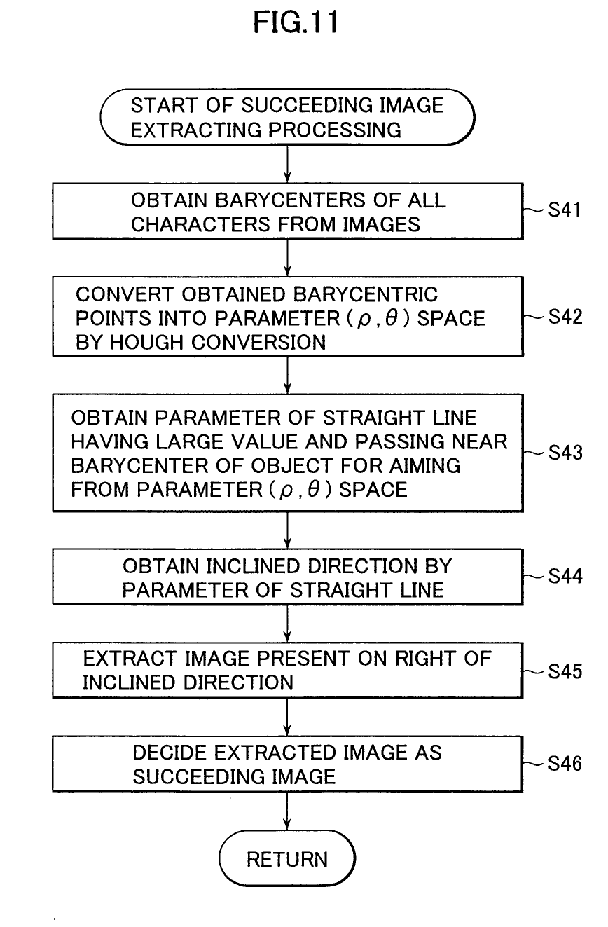

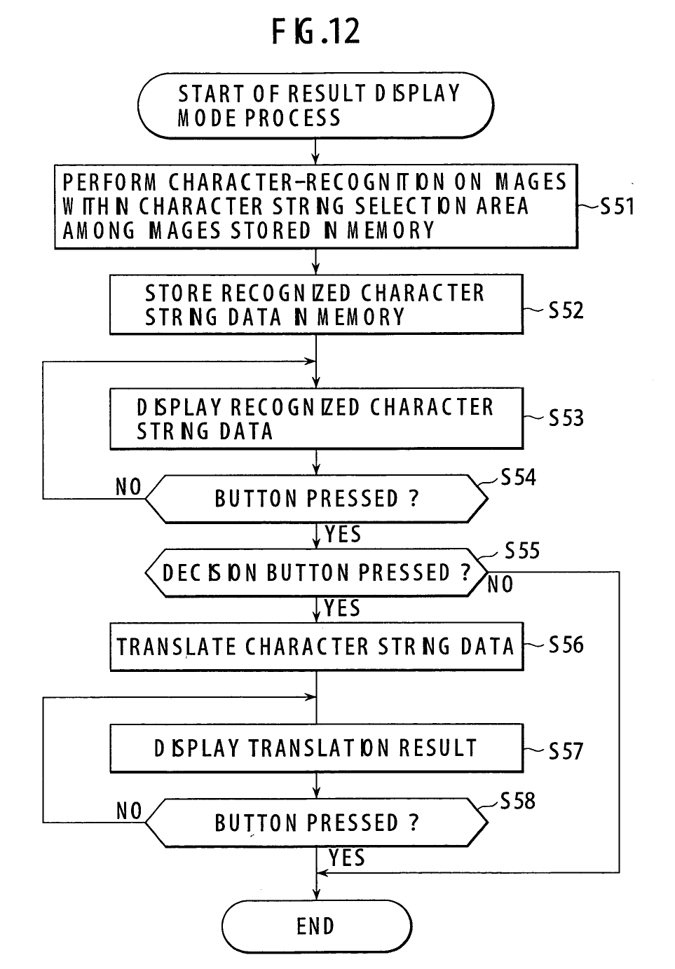

This mobile information terminal device maybe configured to further include extracting means (e.g., the control section 31 of FIG. 2 that performs the processing of FIG. 11) for extracting an image succeeding the image area selected by the selection means when an expansion of the image area is instructed.

This mobile information terminal device maybe configured to further include translating means (e.g., a translating section 38 of FIG. 2 that performs the processing of step S56 of FIG. 12) for translating the recognition result by the recognition means.

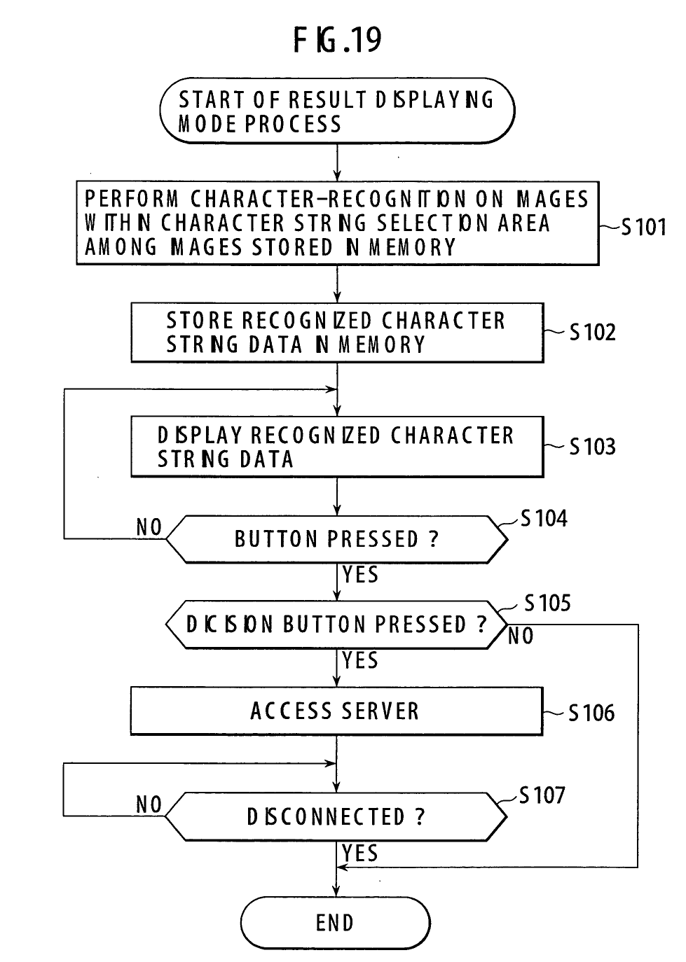

This mobile information terminal device maybe configured to further include accessing means (e.g., the control section 31 of FIG. 2 that performs the processing of step S106 of FIG. 19) for accessing another device based on the recognition result by the recognition means.

Further, the present invention provides an information processing method which includes a photographing step of photographing a subject (e.g., step S11 of FIG. 4), a first display control step of controlling a display operation of images based on the subject photographed by the processing of the photographing step (e.g., step S13 of FIG. 4), a selection step of selecting an image area for recognition from the images the display operation of which is controlled by the processing of the first display control step (e.g., steps S22 to S27 of FIG. 8), a recognition step of recognizing the image area selected by the processing of the selection step (e.g., S52 of FIG. 12), and a second display control step of controlling a display operation of a recognition result by the processing of the recognition step (e.g., step S53 of FIG. 12).

Further, the present invention provides a program causing a computer to perform processing which includes a photographing step of photographing a subject (e.g., step S11 of FIG. 4), a first display control step of controlling a display operation of images based on the subject photographed by the processing of the photographing step (e.g., step S13 of FIG. 4), a selection step of selecting an image area for recognition from the images the display operation of which is controlled by the processing of the first display control step (e.g., steps S22 to S27 of FIG. 8), a recognition step of recognizing the image area selected by the processing of the selection step (e.g., S52 of FIG. 12), and a second display control step of controlling a display operation of a recognition result by the processing of the recognition step (e.g., step S53 of FIG. 12).

This program can be recorded on a recording medium.

Embodiments of the present invention will hereinafter be described with reference to the drawings.

FIG. 1 is a diagram showing an example configuration of the appearance of a built-in camera type mobile telephone to which the present invention is applied.

As shown in FIG. 1, a built-in camera type mobile telephone 1 (hereinafter referred to simply as the mobile telephone 1) is basically constructed of a display section 12 and a body 13, and formed to be foldable at a hinge section 11 in the middle.

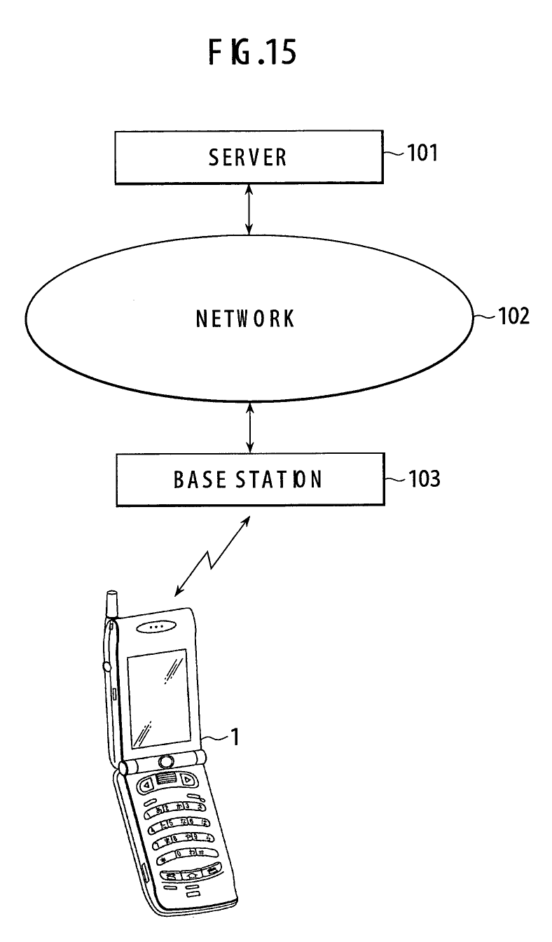

At the upper left corner of the display section 12 is an antenna 21, and through this antenna 21, electric waves are transmitted and received to and from a base station 103 (FIG. 15). In the vicinity of the upper end of the display section 12 is a speaker 22, and from this speaker 22, speech or voice is outputted.

Approximately in the middle of the display section 12 is an LCD (Liquid Crystal Display) 23. The LCD 23 displays text (text to be transmitted as electronic mail) composed by operating input buttons 27, images photographed by a CCD (Charge Coupled Device) camera 29, and the like, besides the signal receiving condition, the charge level of the battery, names and telephone numbers registered as a telephone book, and a call history.

On the other hand, on the body 13 are the input buttons 27 constituted by numerical (ten-key) buttons “0” to “9”, a “*” button, a “#” button. By operating these input buttons 27, a user can prepare a text for transmission as an electronic mail (E-mail), a memo pad, and the like.

Further, in the middle part and above the input buttons 27 of the body 13 is a jog dial 24 that is pivoted about a horizontal axis (extending in left to right directions of the housing), in a manner slightly projecting from the surface of the body 13. For example, according to the operation of rotating this jog dial 24, contents of electronic mails displayed on the LCD 23 are scrolled. On both left and right sides of the jog dial 24 are a left arrow button 24, and a right arrow button 26, respectively. Near the bottom of the body 13 is a microphone 28, whereby user's speech is picked up.

Approximately in the middle of the hinge section 11 is the CCD camera 29 that is rotatably movable within an angular range of 180 degrees, whereby a desired subject (a text written in a book or the like in this embodiment) is photographed.

FIG. 2 is a block diagram showing an example configuration of the internal part of the mobile telephone 1.

A control section 31 is constructed of, e.g., a CPU (Central Processing Unit), a ROM (Read Only Memory), a RAM (Random Access Memory), and the like, and the CPU develops control programs stored in the ROM, into the RAM, to control the operation of the CCD camera 29, a memory 32, a display image generating section 33, a communication control section 34, a speech processing section 36, an image processing/character recognition section 37, a translating section 38, and a drive 39.

The CCD camera 29 photographs an image of a subject, and supplies the obtained image data to the memory 32. The memory 32 stores the image data supplied from the CCD camera 29, and also supplies the stored image data to the display image generating section 33 and the image processing/character recognition section 37. The display image generating section 33 controls a display operation and causes to display the images photographed by the CCD camera 29, character strings recognized by the image processing/character recognition section 37, and the like on the LCD 23.

The communication control section 34 transmits and receives electric waves to and from the base station 103 (FIG. 15) via the antenna 21, and amplifies, e.g., in a telephone conversation mode, an RF (Radio Frequency) signal received at the antenna 21, performs thereon predetermined processes such as a frequency conversion process, an analog-to-digital conversion process, an inverse spectrum spreading process, and then outputs the obtained speech data to the speech processing section 36. Further, the communication control section 34 performs predetermined processes such as a digital-to-analog conversion process, a frequency conversion process, and a spectrum spreading process when the speech data is supplied from the speech processing section 36, and transmits the obtained speech signal from the antenna 21.

The operation section 35 is constructed of the jog dial 24, the left arrow button 25, the right arrow button 26, the input buttons 27, and the like, and outputs corresponding signals to the control section 31 when these buttons are pressed or released from the pressed states by the user.

The speech processing section 36 converts the speech data supplied from the communication control section 34, and outputs a voice of corresponding speech signal from the speaker 22. Further, the speech processing section 36 converts the speech of the user picked up by the microphone 28 into speech data, and outputs the speech signal to the communication control section 34.

The image processing/character recognition section 37 subjects the image data supplied from the memory 32 to character recognition using a predetermined character recognition algorithm, supplies a character recognition result to the control section 31, and also to the translating section 38 as necessary. The translating section 38 holds dictionary data, and translates the character recognition result supplied from the image processing/character recognition section 37 based on the dictionary data, and supplies a translation result to the control section 31.

The drive 39 is connected to the control section 31 as necessary, and a removable medium 40, such as a magnetic disc, an optical disc, a magneto-optical disc, or a semiconductor memory, is installed as appropriate, and computer programs read therefrom are installed to the mobile telephone 1 as necessary.

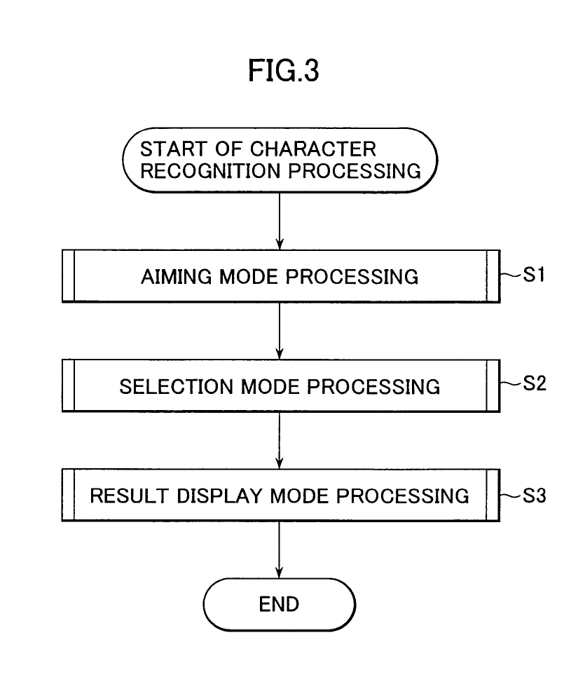

Next, a character recognition processing by the mobile telephone 1 will be described with reference to the flowchart of FIG. 3. This processing is started when an item (not shown) for starting the character recognition processing has been selected from a menu displayed on the LCD 23, e.g., in a case where the user wishes to have a predetermined character string recognized from text written in a book or the like. Further, at this time, the user determines whether the character string for recognition is written horizontally or vertically by selection. Here, a case will be described where the character string for recognition is written horizontally.

In step S1, an aiming mode processing is performed to aim at a character string which the user wishes to recognize, in order to photograph the character string for recognition using the CCD camera 29. By this aiming mode processing, the starting point (head-end character) of images (character string) for recognition is decided. Details of the aiming mode processing in step S1 will be described later with reference to a flowchart of FIG. 4.

In step S2, a selection mode processing is performed to select an image area for recognition, using the image decided by the processing of step S1 as the starting point. By this selection mode processing, the image area (character string) for recognition is decided. Details of the selection mode processing in step S2 will be described later with reference to a flowchart of FIG. 8.

In step S3, a result displaying mode processing is performed to recognize the character string decided by the processing of step S2 and display the recognition result. By this result displaying mode processing, the selected images are recognized, the recognition result is displayed, and the recognized character string is translated. Details of the result displaying mode processing in step S3 will be described later with reference to a flowchart of FIG. 12.

In the above way, the mobile telephone 1 can perform a processing such as photographing text written in a book or the like, selecting and recognizing a predetermined character string from the photographed images, and displaying the recognition result.

Next, the details of the aiming mode processing in step S1 of FIG. 3 will be described with reference to the flowchart of FIG. 4.

The user moves the mobile telephone 1 close to a book or the like in which a character string which the user wishes to recognize is written. And while viewing through-images (so-called images being monitored) being photographed by the CCD camera 29, the user adjusts the position of the mobile telephone 1 such that the head-end character of the character string which the user wishes to recognize coincides with a designated point mark 53 (FIG. 5) displayed therein.

At this time, in step S11, the CCD camera 29 acquires the through-images being photographed, for supply to the memory 32. In step S12, the memory 32 stores the through-images supplied from the CCD camera 29. In step S13, the display image generating section 33 reads the through-images stored in the memory 32, and causes the through-images to be displayed on the LCD 23 together with the designated point mark 53, such as shown in, e.g., FIG. 5.

In the example of FIG. 5, displayed on the LCD 23 are an image display area 51 that displays the photographed images, and a dialogue 52 indicating “Determine the starting point of characters for recognition”. Further, the designated point mark 53 is displayed approximately in the middle of the image display area 51. The user aims at the designated point mark 53 displayed on this image display area 51 so as to coincide with the starting point of images for recognition.

In step S14, the control section 31 extracts through-images within a predetermined area around the designated point mark 53, of the through-images displayed on the LCD 23 by the display image generating section 33. Here, as shown in FIG. 6, an area 61 surrounding the designated point mark 53 is set to the mobile telephone 1 beforehand, and the control section 31 extracts the through-images within this area 61. Note that the area 61 is shown in an imaginary manner to simplify the explanation, and thus is actually managed by the control section 31 as internal information.

In step S15, the control section 31 determines whether or not the images (character string) for recognition are present in the through-images within the area 61 extracted by the processing of step S14. More specifically, for example, when a text is written in black on white paper, it is determined whether or not black images are present within the area 61. Further, for example, various character forms are registered as a database beforehand, and it is determined whether or not characters matching with a character form registered in the database are present within the area 61. Note that the method of determining whether or not images for recognition are present is not limited to those of using color differences between images, using their matching with a database, and the like.

If it is determined in step S15 that the images for recognition are not present, the processing returns to step S11 to perform the above-mentioned processing repeatedly. On the other hand, if it is determined in step S15 that the images for recognition are present, the processing proceeds to step S16, where the control section 31 aims at one of the images for recognition present within the area 61, which is the closest to the designated point mark 53. And the display image generating section 33 synthesizes the image closest to the designated point mark 53 and an aiming-done mark 71, and causes the synthesized image to be displayed on the LCD 23.

FIG. 7 shows an example display of the images synthesized from the images (character string) for recognition and the aiming-done mark 71. As shown in the figure, the aiming-done mark 71 is synthesized with the head-end image “s” of images “snapped” for recognition, for display on the image display area 51. In this way, when the images for recognition are present in the area 61, the image closest to the designated point mark 53 is automatically aimed at, and the aiming-done mark 71 is displayed there-over. Note that the display is switched back to the designated point mark 53 when the images for recognition no longer stay in the area 61 by, e.g., the position of the mobile telephone 1 being adjusted from this aiming-done state.

In step S17, the control section 31 determines whether or not an OK button is pressed by the user, i.e., whether or not the jog dial 24 is pressed. If the control section 31 determines that the OK button is not pressed, the processing returns to step S11 to perform the above-mentioned processing repeatedly. And if it is determined in step S17 that the OK button is pressed by the user, the processing returns to step S2 of FIG. 3 (i.e., moves to the selection mode processing)

By performing such an aiming mode processing, the starting point (head-end character) of a character string which the user wishes to recognize is aimed at.

Next, the details of the selection mode processing in step S2 of FIG. 3 will be described with reference to the flowchart of FIG. 8.

In the above-mentioned aiming mode processing of FIG. 4, when the head (“s” in the present case) of the images (character string) for recognition is aimed at and then the OK button is pressed, in step S21, the display image generating section 33 initializes a character string selection area 81 (FIG. 9) as an area surrounding the currently selected image (i.e., “s”). In step S22, the display image generating section 33 synthesizes the images stored in the memory 32 and the character string selection area 81 initialized by the processing of step S21, and causes the synthesized image to be displayed on the LCD 23.

FIG. 9 shows an example display of the images synthesized from the head of the images for recognition and the character string selection area 81. As shown in the figure, the character string selection area 81 is synthesized and displayed in a manner surrounding the head-end image “s” of the images for recognition. Further, displayed on the dialogue 52 is a message indicating “Determine the ending point of the characters for recognition”. The user presses the right arrow button 26 to expand the character string selection area 81 to the ending point of the images for recognition, according to this message indicated in the dialogue 52.

In step S23, the control section 31 determines whether or not the jog dial 24, the left arrow button 25, the right arrow button 26, an input button 27, or the like is pressed by the user, i.e., whether or not an input signal is supplied from the operation section 35, and waits until it determines that the button is pressed. And if it is determined in step S23 that the button is pressed, the processing proceeds to step S24, where the control section 31 determines whether or not the OK button (i.e., the jog dial 24) is pressed, from the input signal supplied from the operation section 35.

If it is determined in step S24 that the OK button is not pressed, the processing proceeds to step S25, where the control section 31 further determines whether or not a button for expanding the character string selection area 81 (i.e., the right arrow button 26) is pressed, and if determining that the button for expanding the character string selection area 81 is not pressed, the control section 31 judges that the operation is invalid, and thus the processing returns to step S23 to perform the above-mentioned processing repeatedly.

If it is determined in step S25 that the button for expanding the character string selection area 81 is pressed, the processing proceeds to step S26, where a processing of extracting an image succeeding the character string selection area 81 is performed. By this succeeding image extracting processing, an image succeeding the image(s) already selected by the character string selection area 81 is extracted. Details of the succeeding image extracting processing in step S26 will be described with reference to a flowchart of FIG. 11.

In step S27, the display image generating section 33 updates the character string selection area 81 such that the succeeding image extracted by the processing of step S26 is included. Thereafter, the processing returns to step S22 to perform the above-mentioned processing repeatedly. And if it is determined in step S24 that the OK button is pressed, the processing returns to step S3 of FIG. 3 (i.e., moves to the result displaying mode processing).

FIGS. 10A to 10G show operations by which an image area (character string) for recognition is selected by the processing of steps S22 to S27 being repeatedly performed. That is, after deciding the head-end image “s” as the starting point (FIG. 10A), the button for expanding the character string selection area 81 (i.e., the right arrow button 26) is pressed once, whereby “sn” is selected (FIG. 10B). Similarly, the right arrow button 26 is pressed sequentially, whereby characters are selected in the order of “sna” (FIG. 10C) , “snap” (FIG. 10D) , “snapp” (FIG. 10E), “snappe” (FIG. 10F) , and “snapped” (FIG. 10G).

By such a selection mode processing being performed, the range (from the starting point to the ending point) of a character string which the user wishes to recognize is decided.

Note that by pressing the left arrow button 25, the selection is released sequentially for the characters, although not shown in the drawing. For example, in a state in which “snapped” is selected by the character string selection area 81 (FIG. 10G), when the left arrow button 25 is pressed once, the selection of “d” is released to update the character string selection area to a state in which “snappe” (FIG. 10F) is selected.

Referring next to the flowchart of FIG. 11, the details of the processing of extracting an image succeeding the character string selection area 81 in the processing of step S26 of FIG. 8 will be described.

In step S41, the control section 31 extracts all images, which are characters, from the images, and obtains their barycentric points (xᵢ, yᵢ) (i=1, 2, 3 . . . ). In step S42, the control section 31 subjects all the barycentric points (xᵢ, yᵢ) obtained by the processing of step S41 to θρ-Hough conversion for conversion into a (ρ, θ) space.

Here, the θρ-Hough conversion means an algorithm used for detecting straight lines in image processing, and it converts an (x, y) coordinate space into the (ρ, θ) space, using the following equation (1).
ρ=x·cos+y·sin θ (1)

When θρ-Hough conversion is performed on, e.g., one point (x′, y′) in the (x, y) coordinate space, a sinusoidal wave represented by the following equation (2) results in the (ρ, θ) space.
ρ=x′·cos+y′·sin θ (2)

Further, when θρ-Hough conversion is performed on, e.g., two points in the (x, y) coordinate space, sinusoidal waves have an intersection at a predetermined portion in the (ρ, θ) space. The coordinates (ρ′, θ′) of the intersection become a parameter of a straight line passing through the two points in the (x, y) coordinate space represented by the following equation (3).
ρ=x·cos+y·sin θ (3)

Further, when θρ-Hough conversion is performed on, e.g., all the barycentric points of the images, which are characters, there may be many portions at which sinusoidal waves intersect in the (ρ, θ) space. A parameter for the intersecting positions becomes a parameter of a straight line passing through a plurality of centers of gravity in the (x, y) coordinate space, i.e., a parameter of a straight line passing through a character string.

When the number of intersections in the sinusoidal waves is set as a value in the (ρ, θ) coordinate space, there may be a plurality of portions each having a large value in images wherein there are a plurality of lines. Thus, in step S43, the control section 31 finds one of parameters of such straight lines as to have such large values and also pass near the barycenter of an object for aiming, and takes it as a parameter of the straight line to which the object for aiming belongs.

In step S44, the control section 31 obtains the orientation of the straight line from the parameter of the straight line obtained by the processing of step S43. In step S45, the control section 31 extracts an image present on the right in terms of the orientation defined by the parameter of the straight line obtained by the processing of step S44. Instep S46, the control section 31 judges the image extracted by the processing of step S45 as a succeeding image, and then the processing returns to step S27.

Note that the user determines by selection that the characters for recognition are written horizontally when starting the character recognition processing of FIG. 3 and thus that the image is extracted which is present on the right in terms of the orientation. However, when it is determined by selection that the characters for recognition are written vertically, an image below in terms of the orientation is extracted.

By a succeeding image extracting processing such as above being performed, image(s) succeeding (on the right or below) the current character string selection area 81 is extracted.

Referring next to the flowchart of FIG. 12, the details of the result displaying mode processing in step S3 of FIG. 3 will be described.

In the above-mentioned selection mode processing of FIG. 8, when the images (character string) for recognition are selected by the character string selection area 81 and the OK button is pressed, in step S51, the image processing/character recognition section 37 recognizes the images within the character string selection area 81 (“snapped” in the present case) using the predetermined character recognition algorithm.

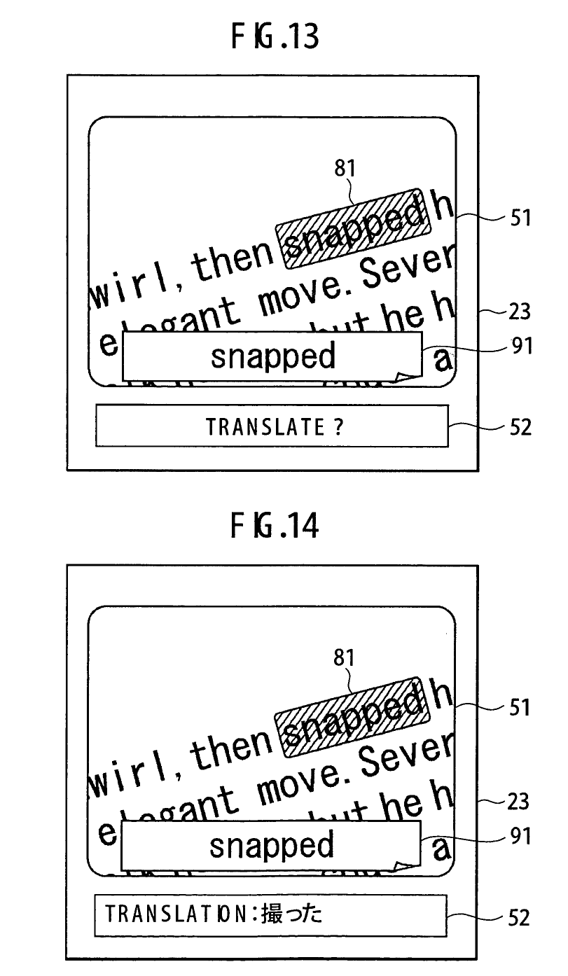

In step S52, the image processing/character recognition section 37 stores the character string data which is a character recognition result obtained by the processing of step S51, in the memory 32. In step S53, the display image generating section 33 reads the character string data, which is the character recognition result stored in the memory 32, and causes images such as shown in, e.g., FIG. 13 to be displayed on the LCD 23.

In the example of FIG. 13, a character recognition result 91 indicating “snapped” is displayed on the image display area 51, and a message indicating “Do you wish to translate it?” is displayed on the dialogue 52. The user presses the OK button (jog dial 24) according to this message indicated in the dialogue 52. As a result, the mobile telephone 1 can translate the recognized characters.

In step S54, the control section 31 determines whether or not a button, such as the jog dial 24, the left arrow button 25, the right arrow button 26, or an input button 27, is pressed by the user, i.e., whether or not an input signal is supplied from the operation section 35, and if the control section 31 determines that the button is not pressed, the processing returns to step S53 to perform the above-mentioned processing repeatedly.

And if it is determined in step S54 that the button is pressed, the processing proceeds to step S55, where the control section 31 further determines whether or not the OK button is pressed by the user, i.e., whether or not the jog dial 24 is pressed. If it is determined in step S55 that the OK button is pressed, the processing proceeds to step S56, where the translating section 38 translates the character data recognized by the image processing/character recognition section 37 by the processing of step S51 and displayed on the LCD 23 as the recognition result by the processing of step S53, using the predetermined dictionary data.

In step S57, the display image generating section 33 causes a translation result obtained by the processing of step S56 to be displayed on the LCD 23 as shown in, e.g., FIG. 14.

In the example of FIG. 14, the character recognition result 91 indicating “snapped” is displayed on the image display area 51, and a translation result indicating “Translation: [symbol] ” is displayed on the dialogue 52. In this way, the user can translate a selected character string easily.

In step S58, the control section 31 determines whether or not a button, such as the jog dial 24, the left arrow button 25, the right arrow button 26, or an input button 27, is pressed by the user, i.e., whether or not an input signal is supplied from the operation section 35, and if the control section 31 determines that the button is not pressed, the processing returns to step S57 to perform the above-mentioned processing repeatedly. And if it is determined in step S58 that the button is pressed, the processing is terminated.

By such a result displaying mode processing being performed, the recognized character string is displayed as a recognition result, and the recognized character string is translated as necessary.

Further, in displaying a recognition result, an application (e.g., an Internet browser, translation software, text composing software, or the like) which utilizes the recognized character string can be selectively displayed. Specifically, when “Hello” is displayed as a recognition result, translation software or text composing software is displayed so as to be selectable via icons or the like. And when the translation software is selected by the user, it is translated into “ [symbol] ”, and when the text composing software is selected, “Hello” is inputted into a text composing screen.

In the above way, the mobile telephone 1 can photograph text written in a book or the like using the CCD camera 29, character-recognize photographed images, and translate the character string obtained as a recognition result easily. That is, the user can translate a character string which he or she wishes to translate easily, by merely causing the CCD camera 29 of the mobile telephone 1 to photograph the character string, without typing to input the character string.

Further, since there is no need to take care of the size of characters for recognition and the orientation of the character string for recognition, a burden of operation imposed on the user, such as position matching for a character string, can be reduced.

In the above, it is arranged such that a character string (an English word) written in a book or the like is photographed by the CCD camera 29, to character-recognize photographed images and translate the character string obtained by the character recognition. However, the present invention is not limited thereto. For example, a URL (Uniform Resource Locator) written in a book or the like can be photographed by the CCD camera 29, to character-recognize the photographed images and access a server or the like based on the URL obtained by the character recognition.

FIG. 15 is a diagram showing an example configuration of a server access system to which the present invention is applied. In this system, connected to a network 102 such as the Internet are a server 101, and also the mobile telephone 1 via the base station 103 that is a fixed wireless terminal.

The server 101 is constructed of a workstation, a computer, or the like, and a CPU (not shown) thereof executes a server program to distribute a compact HTML (Hypertext Markup Language) file concerning a home page made thereby, via the network 102, based on a request from the mobile telephone 1.

The base station 103 wirelessly connects the mobile telephone 1, which is a movable wireless terminal, by, e.g., a code division multiple connection called W-CDMA (Wideband-Code Division Multiple Access), for transmission of a large volume of data at high speeds.

Since the mobile telephone 1 can transmit a large volume of data at high speeds by the W-CDMA system to the base station 103, it can perform a wide variety of data communications such as exchange of electronic mail, browsing of simple home pages, exchange of images, besides telephone conversations.

Further, the mobile telephone 1 can photograph a URL written in a book or the like using the CCD camera 29, character-recognize the photographed images, and access the server 101 based on the URL obtained by the character recognition.

Referring next to the flowchart of FIG. 3 again, a character recognition processing by the mobile telephone 1 shown in FIG. 15 will be described. Note that descriptions that overlap what is described above will be omitted whenever appropriate.

In step S1, by the aiming mode processing being performed, the starting point (head-end character) of images for recognition (URL) is decided. In step S2, by the selection mode processing being performed, an image area for recognition is decided. In step S3, by the result displaying mode processing being performed, the selected images are recognized, its recognition result (URL) is displayed, and the server 101 is accessed based on the recognized URL.

Referring next to the flowchart of FIG. 4 again, details of the aiming mode processing in step S1 of FIG. 3 will be described.

The user moves the mobile telephone 1 nearer to a book or the like in which a URL is written. And while viewing through-images being photographed by the CCD camera 29, the user adjusts the position of the mobile telephone 1 such that the head-end character of the URL which the user wishes to recognize (h in the current case) coincides with the designated point mark 53 (FIG. 16) displayed therein.

At this time, in step S11, the CCD camera 29 acquires the through-images being photographed, and in step S12, the memory 32 stores the through-images. Instep S13, the display image generating section 33 reads the through-images stored in the memory 32, and causes the through-images to be displayed on the LCD 23 together with the designated point mark 53, such as shown in, e.g., FIG. 16.

In the example of FIG. 16, displayed on the LCD 23 are the image display area 51 for displaying photographed images, and the dialogue 52 indicating “Determine the starting point of characters for recognition”. Further, the designated point mark 53 is displayed approximately in the middle of the image display area 51. The user aims at the designated point mark 53 displayed on this image display area 51 so as to coincide with the starting point of the images for recognition.

In step S14, the control section 31 extracts a through-image within a predetermined area 61 (FIG. 6) around the designated point mark 53, of the through-images displayed on the LCD 23 by the display image generating section 33. In step S15, the control section 31 determines whether or not the images for recognition (URL) are present in the through-image within the area 61 extracted by the processing of step S14, and if the control section 31 determines that the images for recognition are not present, the processing returns to step S11 to execute the above-mentioned processing repeatedly.

If it is determined in step S15 that the images for recognition are present, the processing proceeds to step S16, where the control section 31 aims at one of the images for recognition present within the area 61, which is closest to the designated point mark 53. And the display image generating section 33 synthesizes the image closest to the designated point mark 53 and the aiming-done mark 71 (FIG. 7), and causes the synthesized image to be displayed on the LCD 23.

In step S17, the control section 31 determines whether or not the OK button is pressed by the user, i.e., whether or not the jog dial 24 is pressed. If the control section 31 determines that the OK button is not pressed, the processing returns to step S11 to perform the above-mentioned processing repeatedly. And if it is determined in step S17 that the OK button is pressed by the user, the processing returns to step S2 of FIG. 3 (i.e., moves to the selection mode processing)

By such an aiming mode processing being performed, the starting point (head-end character) of a character string which the user wishes to recognize is aimed at.

Referring next to FIG. 8 again, details of the selection mode processing in step S2 of FIG. 3 will be described.

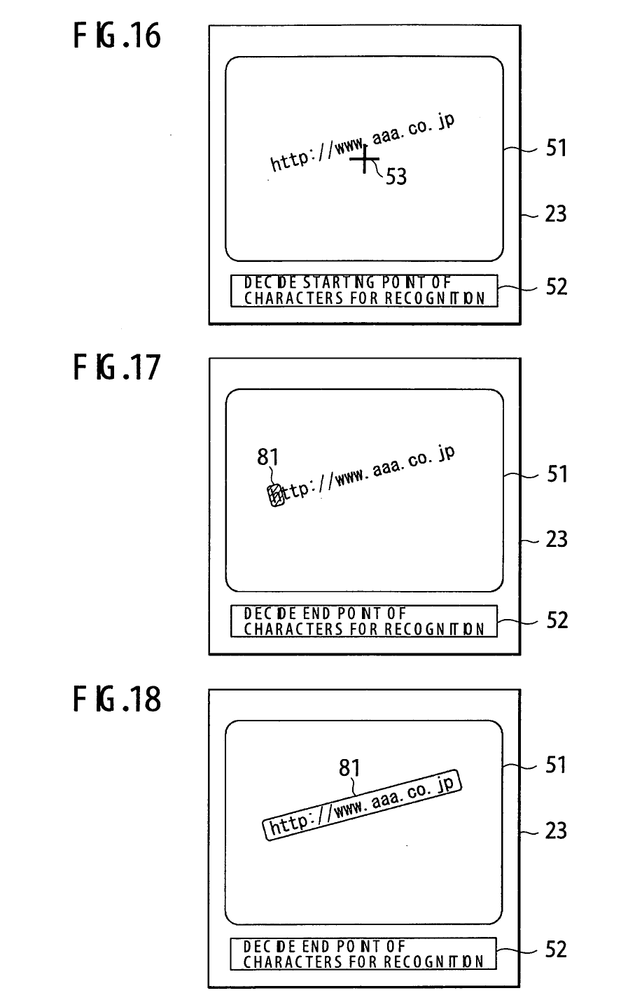

In step S21, the display image generating section 33 initializes the character string selection area 81 (FIG. 17), and in step S22, synthesizes the images stored in the memory 32 and the initialized character string selection area 81, and causes the synthesized image to be displayed on the LCD 23.

FIG. 17 shows an example display of the images synthesized from the head of the images for recognition and the character string selection area 81. As shown in the figure, the character string selection area 81 is synthesized for display in a manner surrounding the head-end image “h” of the images for recognition. Further, the dialogue 52 displays a message indicating “Determine the ending point of the characters for recognition”. The user presses the right arrow button 26 to expand the character string selection area 81 to the ending point of the images for recognition, according to this message indicated in the dialogue 52.

In step S23, the control section 31 determines whether or not a button is pressed by the user, and waits until it determines that the button is pressed. And if it is determined in step S23 that the button is pressed, the processing proceeds to step S23, where the control section 31 determines whether or not the OK button (i.e., the jog dial 24) is pressed, from an input signal supplied from the operation section 35. If the control section 31 determines that the OK button is not pressed, the processing proceeds to step S25.

In step S25, the control section 31 further determines whether or not the button for expanding the character string selection area 81 (i.e., the right arrow button 26) is pressed, and if determining that the button for expanding the character string selection area 81 is not pressed, the control section 31 judges that the operation is invalid, and thus the processing returns to step S23 to perform the above-mentioned processing repeatedly. If it is determined in step S25 that the button for expanding the character string selection area 81 is pressed, the processing proceeds to step S26, where the control section 31 extracts an image succeeding the character string selection area 81 as mentioned above with reference to the flowchart of FIG. 11.

In step S27, the display image generating section 33 updates the character string selection area 81 such that the succeeding image extracted by the processing of step S26 is included. Thereafter, the processing returns to step S22 to perform the above-mentioned processing repeatedly. And if it is determined in step S24 that the OK button is pressed, the processing returns to step S3 of FIG. 3 (i.e., moves to the result displaying mode processing).

FIG. 18 shows how images for recognition are selected by the character string selection area 81 by the processing of steps S22 to S27 being performed repeatedly. In the example of FIG. 18, http://www.aaa.co.jp, which is a URL, is selected by the character string selection area 81.

By such a selection mode processing being performed, the range (from the starting point to the ending point) of a character string which the user wishes to recognize is decided.

Referring next to a flowchart of FIG. 19, details of the result displaying mode in step S3 of FIG. 3 will be described. Note that descriptions that overlap what is described above will be omitted whenever appropriate.

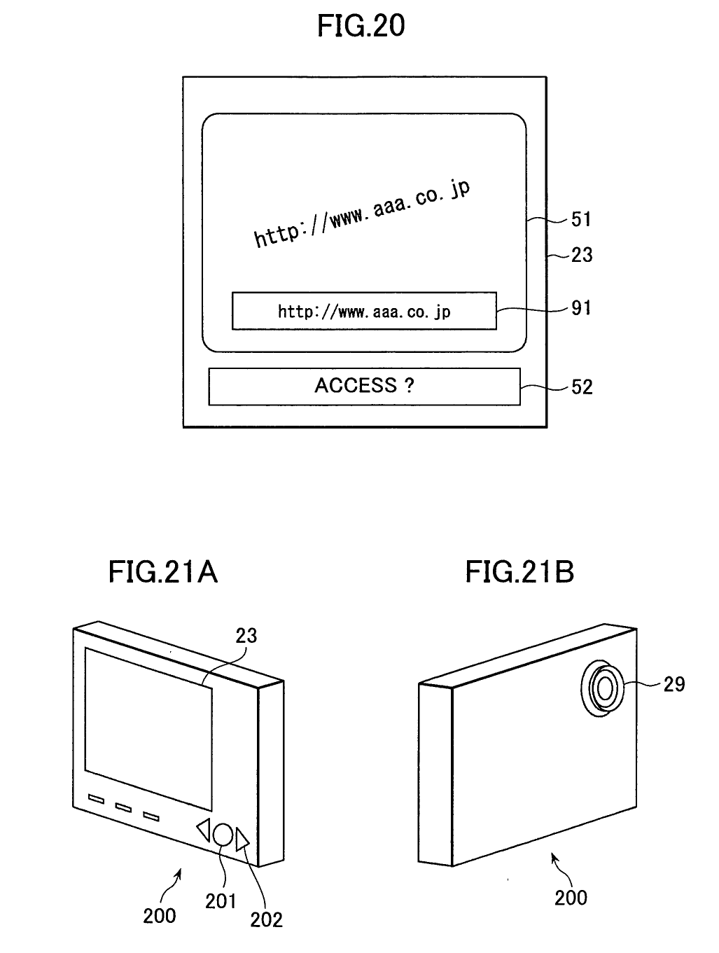

In step S101, the image processing/character recognition section 37 character-recognizes images within the character string selection area 81 (“http://www.aaa.co.jp” in the present case) of the images stored in the memory 32, using the predetermined character recognition algorithm, and in step S102, causes the character string data, which is a character recognition result, to be stored in the memory 32. In step S103, the display image generating section 33 reads the character string data, which is the character recognition result stored in the memory 32, and causes a screen such as shown in, e.g., FIG. 20, to be displayed on the LCD 23.

In the example of FIG. 20, the character recognition result 91 indicating “http://www.aaa.co.jp” is displayed on the image display area 51, and a message indicating “Do you wish to access?” is displayed on the dialogue 52. The user presses the OK button (jog dial 24) according to this message indicated in the dialogue 52. As a result, the mobile telephone 1 accesses the server 101 based on the recognized URL, whereby the user can browse a desired home page.

In step S104, the control section 31 determines whether or not a button is pressed by the user, and if the control section 31 determines that the button is not pressed, the processing returns to step S103 to perform the above-mentioned processing repeatedly. And if it is determined in step S104 that the button is pressed, the processing proceeds to step S105, where the control section 31 further determines whether or not the OK button is pressed by the user, i.e., whether or not the jog dial 24 is pressed.

If it is determined in step S105 that the OK button is pressed, the processing proceeds to step S106, where the control section 31 accesses the server 101 via the network 102 based on the URL character-recognized by the image processing/character recognition section 37 by the processing of step S101.

In step S107, the control section 31 determines whether or not the server 101 is disconnected by the user, and waits until the server 101 is disconnected. And if it is determined in step S107 that the server 101 is disconnected, or if it is determined in step S105 that the OK button is not pressed (i.e., access to the server 101 is not instructed), the processing is terminated.

By such a result displaying mode processing being performed, the recognized URL is displayed as a recognition result, and a predetermined server is accessed based on the recognized URL as necessary.

As described above, the mobile telephone 1 can photograph a URL written in a book or the like using the CCD camera 29, character-recognize the photographed images, and access the server 101 or the like based on the URL obtained as a recognition result. That is, the user is enabled to access the server 101 easily to browse the desired home page by merely causing the CCD camera 29 of the mobile telephone 1 to photograph a URL of the home page the user wishes to browse, without typing to input the URL.

In the above, the case where the present invention is applied to the mobile telephone 1 has been described. However, not limited thereto, the present invention can be applied broadly to mobile information terminal devices having the CCD camera 29 that photographs character strings written in a book or the like, the LCD 23 that displays the images photographed by the CCD camera 29 and recognition results, and the operation section 35 that selects a character string for recognition, expands the character string selection area 81, or performs various operations.

FIG. 21 shows an example configuration of the appearance of a mobile information terminal device to which the present invention is applied. FIG. 21A shows a frontal perspective view of a mobile information terminal device 200, and FIG. 21B shows a back perspective view of the mobile information terminal device 200. As shown in the figures, in the front of the mobile information terminal device 200 are the LCD 23 for displaying through-images, recognition results, and the like, an OK button 201 for selecting characters for recognition, an area expanding button 202 for expanding the character sting selection area 81, and the like. Further, on the back of the mobile information terminal device 200 is the CCD camera 29 for photographing text or the like written in a book.

By using the mobile information terminal device 200 having such a configuration, one can photograph a character string written in a book or the like, character-recognize the photographed images, translate the character string obtained as a recognition result, or access a predetermined server, for example.

Note that the configuration of the mobile information terminal device 200 is not limited to that shown in FIG. 21, but may be configured to provide a jog dial, in place of, e.g., the OK button 201 and the expansion button 202.

The above-mentioned series of processing maybe performed by hardware and software. When the series of processing is to be performed by software, a program constituting the software is installed to a computer incorporated into dedicated hardware, or, e.g., to a general-purpose personal computer which can perform various functions by installing various programs thereto, via a network or a recording medium.

This recording medium is, as shown in FIG. 2, constructed not only of the removable disk 40, such as a magnetic disc (including a flexible disc), an optical disc (including a CD-ROM (Compact Disc-Read Only Memory), a DVD (Digital Versatile Disc)), a magneto-optical disc (including an MD (Mini-Disc) (trademark)), or a semiconductor memory, which is distributed to a user to provide the program separately from the apparatus body, and on which the program is recorded, but also of a ROM and a storage section which are provided to the user while incorporated into the apparatus body beforehand, and in which the program is recorded.

Note that in the present specification, the steps writing the program recorded on a recording medium include not only processing performed time-sequentially in the written order, but also processing performed in parallel or individually, although not necessarily processed time-sequentially.

1. A mobile information terminal device comprising:
photographing means for photographing a subject;
first display control means for controlling a display operation of images based on the photographed subject by the photographing means;
selection means for selecting an image area for recognition from the images the display operation of which is controlled by the first display control means;
recognition means for recognizing the image area selected by the selection means; and
second display control means for controlling the display operation of a recognition result obtained by the recognition means.

2. The mobile information terminal device as cited in claim 1, wherein;
said selection means is configured to select a starting point and an ending point of the image area for recognition.

3. The mobile information terminal device as cited in claim 1, further comprising aiming control means, wherein;
said first display control means further controls the display operation of a mark for designating the starting point of the images is configured to further include aiming control means for further controlling; and
said aiming control means controls to aim at the image for recognition when the images for recognition are present near the mark.

4. The mobile information terminal device as cited in claim 1, further comprising:
extracting means for extracting an image succeeding the image area when an expansion of the image area selected by the selection means is instructed.

5. The mobile information terminal device as cited in claim 1, further comprising:
translating means for translating the recognition result obtained by the recognition means.

6. The mobile information terminal device as cited in claim 1, further comprising:
accessing means for accessing another device based on the recognition result obtained by the recognition means.

7. An information processing method comprising:
a photographing step of photographing a subject;
a first display control step of controlling a display operation of images based on the photographed subject by the processing of the photographing step;
a selection step of selecting an image area for recognition from the images the display operation of which is controlled by the processing of the first display control step;
a recognition step of recognizing the image area selected by the processing of the selection step; and
a second display control step of controlling the display operation of a recognition result by the processing of the recognition step.

8. A recording medium on which a program causing a computer to perform a processing is recorded, said processing comprising:
a photographing step of photographing a subject;
a first display control step of controlling a display operation of images based on the subject photographed by the processing of the photographing step;
a selection step of selecting an image area for recognition from the images the display operation of which is controlled by the processing of the first display control step;
a recognition step of recognizing the image area selected by the processing of the selection step; and
a second display control step of controlling a display operation of a recognition result by the processing of the recognition step.

9. A program causing the computer to perform a processing comprising:
a photographing step of photographing a subject;
a first display control step of controlling a display operation of images based on the subject photographed by the processing of the photographing step;
a selection step of selecting an image area for recognition from the images the display operation of which is controlled by the processing of the first display control step;
a recognition step of recognizing the image area selected by the processing of the selection step; and
a second display control step of controlling a display operation of a recognition result by the processing of the recognition step.
